(19) United States
(12) Patent Application Publication
(10) Pub. No.: US 2026/0043362 A1
(43) Pub. Date: Feb. 12, 2026

(54) AUTOMATED CONTROL OF TURBINE ENGINES OF A ROTARY-WING AIRCRAFT DURING A FAILURE ON A TURBINE ENGINE

(71) Applicant: SAFRAN HELICOPTER ENGINES, Bordes (FR)

(72) Inventors: Philippe Roger COURTIE, Moissy-Cramayel (FR); Pascal Jean RUPERT, Moissy-Cramayel (FR)

(73) Assignee: SAFRAN HELICOPTER ENGINES, Bordes (FR)

(21) Appl. No.: 19/140,224

(22) PCT Filed: Dec. 19, 2023
(86) PCT No.: PCT/FR2023/052052

§ 371 Date: Jun. 17, 2025

(30) Foreign Application Priority Data
Dec. 19, 2022 (FR) 2213819

(51) Int. Cl. F02C 9/42; F02C 9/46

(52) U.S. Cl. CPC F02C 9/42; F02C 9/46; F05D 2220/329; F05D 2270/053; F05D 2270/093; F05D 2270/13

(57) ABSTRACT

Automated control method for turbine engines of a rotary-wing aircraft during a breakdown of one turbine engine.

Following a detection of a breakdown of one first turbine engine of the aircraft, the automated control method comprises:
determining (102) the flight phase, then, when the aircraft is in a phase other than a takeoff phase,
activating (110) operation of the turbine engines in a misaligned mode via a progressive reduction of the power of the first turbine engine and a progressive increase of the power of at least one second turbine engine, the progressive reduction in power of the first turbine engine and the progressive increase in power of said at least one second turbine engine being controlled in a complementary manner to maintain the rotation speed of the rotary wing at the speed at the rotation speed setpoint of the rotary wing, and
activating (120) an indicator of an engine anomaly, and
setting (130) a power limiter.

### TECHNICAL FIELD

The present invention relates to the general field of aircraft comprising at least two turbine engines, and more particularly to control management of the turbine engines in the event of detecting a breakdown in one of the turbine engines.

### PRIOR ART

Generally, in a two-engine aircraft or one with even more than two turbine engines, when a breakdown appears in one of the turbine engines, the pilot is required to engage a manual procedure. This manual procedure consists of idling or stopping the engine having a breakdown that could damage it.

This procedure has the disadvantage of increasing the pilot's workload and generating errors leading to the stopping of the healthy engine.

This type of procedure is described in the installation manuals of engines installed on multi-engine helicopters for example. The procedure could be summarized as follows: “in the event of a breakdown that could damage the engine (low oil pressure, metal shavings, low oil level, filter clogging), it is recommended to immediately idle the engine or to stop it.”

### DISCLOSURE OF THE INVENTION

To this end, the present invention seeks to improve the safety of flights by reducing the pilot workload and particularly by avoiding recourse to selectors, potential pilot error sources.

In one object of the invention, an automated control method for the turbine engines of a rotary-wing aircraft provided with a plurality of turbine engines is proposed during a breakdown of one turbine engine, the method being intended to be implemented by an electronic control unit configured to receive a rotation speed setpoint of the rotary wing.

According to a technical feature of the invention, following detection of a breakdown of a first turbine engine among the turbine engines of the rotary-wing aircraft, the automated control method comprises:
determining the flight phase in which the aircraft is situated, then, when the aircraft is a phase other than a takeoff phase,
activating operation of the turbine engines in a misaligned mode via commanding a progressive reduction in power of said first turbine engine and commanding a progressive increase in power of at least one second turbine engine of the aircraft, the progressive reduction in power of the first turbine engine and the progressive increase in power of said at least one second turbine engine being controlled in a complementary manner to maintain the rotation speed of the rotary wing at the rotation speed setpoint of the rotary wing,
activating an indicator, for the pilot, of an engine anomaly related to the detected breakdown, inviting the pilot to employ prudent piloting, and
setting a power limiter configured to limit the power of the turbine engines of the aircraft to a first maximum available power threshold (OEIH) corresponding to a maximum power usable by a turbine engine for a first limited period.

The rotary wing speed setpoint corresponds to the desired rotation speed of the rotary wing and generally originates in the avionics which transmits it to the control system, i.e. the electronic control unit.

The invention thus allows totally automatic management of engine breakdown cases, reducing the pilot workload and limiting the risk of errors and accommodating both power availability, reduction of loading of the inoperative engine and limitation of incursion into the emergency power regimes of the healthy engines. During operation with an inoperative turbine engine, the emergency power regimes (OEIH, OEIL, OEIC) i.e. regimes above a certain threshold, are qualified as OEI regimes, for “One Engine Inoperative”. In greater detail, there exists the OEIH regime for a “high” regime, the OEIL regime for a “low” regime, and the OEIC regime for a continuous regime. For example, the OEIH regime can be a regime that is accessible for 30 seconds while the OEIL regime is a regime accessible for 2 minutes, and the OEIC regime is accessible continuously, the OEIH regime being higher than the OEIL regime, itself being higher than the OEIC regime.

In fact, the method according to the invention improves flight safety during a breakdown of a turbine engine due to automatic management of the reduction of power on the inoperative engine, in order to reduce its damage while favoring the availability of power, and limiting incursions into the OEI regimes of the other engines, in order to avoid heavy maintenance operations.

The method implemented by an automated system allows reducing the pilot workload and the risks of a bad decision (in particular the stopping of the healthy engine), while retaining the “spirit” of the usual recommendations (pilot habits). This automated system is activated when breakdowns which could lead to damage to the engine are detected and made known to the system. Typically these are breakdowns of the oil system. The system then automatically manages the reduction in power on the inoperative engine in order to limit the damage and automatically compensates using the other engines.

The method of the invention has as its basic principle to replace management by the pilot of an engine breakdown situation with completely automated management by an electronic control and engine monitoring unit. This relates in particular to cases of breakdowns of the oil system and offers automatic management ensuring both power availability, reduced loading of the inoperative engine and limitation in incursions into the OEI regime of the other engines. Thus, the proposed invention seeks to reduce pilot workload while retaining the main principles of the management initially performed when these functions were performed manually by pilots.

In a first implementation mode of the method according to the invention, a takeoff phase is detected when the power delivered by at least one turbine engine is greater than a maximum continuous power threshold.

In a second implementation mode of the invention, the method can also comprise, prior to activating operation of the turbine engines in a misaligned mode, verifyini the operating state of all the turbine engines, the misaligned mode being held inactive if a breakdown impacting the nominal operation of at least one turbine engine is also detected on at least one of the turbine engines.

During nominal operation of a turbine engine, the safety of the turbine engine is ensured, and there exists no risk that its integrity is affected.

What is meant by the expression a breakdown impacting the nominal operation is a breakdown not allowing ensuring operation of the turbine engine of the aircraft with full safety for the turbine engine. A breakdown impacting the nominal operation of a turbine engine can be a breakdown in the sensors or actuators, for example.

In a third implementation mode of the method according to the invention, the progressive reduction in power of said first turbine engine and the progressive increase in power of at least one second turbine engine of the aircraft are accomplished until the power of the first turbine engine reaches a lower power limit, the power of said at least one second turbine engine remaining less than a second maximum available power threshold (OEIL), or until the power of said at least one second turbine engine reaches the second maximum available power threshold (OEIL), or until the power of said at least one second turbine engine reachs the second maximum available power threshold (OEIL), the power of said first turbine engine having a value greater than said lower power limit of the first turbine engine.

In a fourth implementation mode of the method according to the invention, if, following the activation of operation of the turbine engines in a misaligned mode, a pilot issues a power increase request, the method comprises a command to increase the power of said at least one second turbine engine until, at most, a second maximum available power threshold (OEIL), and, if the increase in power of said at least one second turbine engine is insufficient for the turbine engines to develop in total the power required by the pilot, a command for increasing the power of said first turbine engine until, at most, the second maximum available power threshold (OEIL), the increase in power of said at least one second turbine engine and, if needed, of said first turbine engine being accomplished for a limited period.

Nevertheless, if the rotary wing speed setpoint cannot be reached in this manner, the increase in power on the turbine engines remains possible until the first maximum available power threshold (OEIH).

In a fifth implementation mode of the method according to the invention, the pilot commands the setting of a power limiter to limit the power of the turbine engines of the aircraft to a second maximum available power threshold (OEIL) corresponding to a maximum power usable by a turbine engine for a second limited period greater than the first limited period, the second maximum available power threshold (OEIL) being less than the first maximum available power threshold (OEIH).

In a sixth implementation mode of the method according to the invention, if, following the activation of operation of the turbine engines in a misaligned mode, a pilot issues a power increase request, the method comprises a command to increase the power of said at least one second turbine engine until, at most, a third maximum available power threshold (OEIC) less than the second maximum available power threshold (OEIL), and, if the increase in power of said at least one second turbine engine is insufficient for the turbine engines to develop in total the power required by the pilot, a command to increase the power of said first turbine engine until, at most, the third maximum available power threshold (OEIC), the increase in power in said at least one second turbine engine and, if needed, in said first turbine engine which can be accomplished for an unlimited period.

Nevertheless, if the speed setpoint of the rotary wing cannot be reached in this way, the increase in power in the turbine engines remains possible until the second maximum available power threshold (OEIL).

According to another object of the invention, an electronic control unit is proposed for a rotary-wing aircraft provided with a plurality of turbine engines, the electronic control unit being configured to receive a rotation speed setpoint of the rotary wing and automatically control the turbine engines of the aircraft during a breakdown of one turbine engine, the electronic control unit comprising:
an input module configured to receive signals detecting a breakdown in a first turbine engine among the turbine engines of the rotary-wing aircraft,
a means for determining the flight phase in which the aircraft is situated,
a means for activating operation of the turbine engines in a misaligned mode configured to deliver, when the aircraft is in a phase other than a takeoff phase, a command to progressively reduce the power of said first turbine engine and a command to progressively increase the power of at least one second turbine engine of the aircraft, the progressive reduction in power of the first turbine engine and the progressive increase in power of said at least one second turbine engine being controlled in a complementary manner to maintain the rotation speed of the rotary wing at the rotation speed of the rotation setpoint of the rotary wing, and
a means for activating an indicator of an engine anomaly for the pilot, inviting him to employ prudent piloting, and
a means for setting a power limiter configured to limit the power of the turbine engines of the aircraft to at least a first maximum available power threshold (OEIH) corresponding to a maximum power usable by a turbine engine for a first limited period.

The rotary wing speed setpoint corresponds to the desired speed of rotation of the rotary wing and generally originates in the avionics which transmit it to the control system, i.e. the electronic control unit.

According to another object of the invention, a rotary wing aircraft is proposed comprising at least two turbine engines and an electronic control unit.

### BRIEF DESCRIPTION OF THE DRAWINGS

FIG. 1 illustrates an automated control method for the turbine engines of a rotary wing aircraft during a breakdown of a turbine engine, according to one implementation mode.

FIG. 2 illustrates an automated control method for the turbine engines of a rotary wing aircraft during a breakdown of a turbine engine, according to a second implementation mode.

FIG. 3 illustrates an automated control method for the turbine engines of a rotary-wing aircraft during a breakdown of a turbine engine, according to a third implementation mode of the invention.

FIG. 4 shows schematically an electronic control unit according to one embodiment of the invention.

FIG. 5 shows graphically the evolution of the speeds of the two turbine engines of an aircraft when the method of FIG. 1 is implemented.

FIG. 6 shows graphically the evolution of the speeds of the two turbine engines of an aircraft when the method of FIG. 1 is implemented while the aircraft is in the takeoff phase when a breakdown is detected.

FIG. 7 shows graphically the evolution of the speeds of the two turbine engines of an aircraft when the method of FIG. 2 is implemented.

### DESCRIPTION OF THE EMBODIMENTS

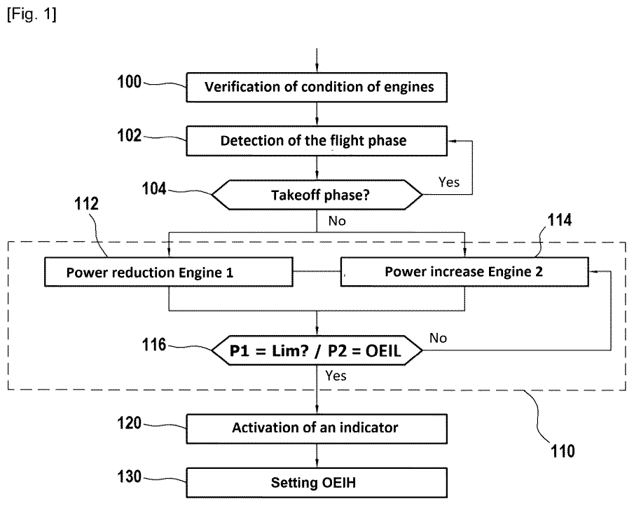

A flowchart of an automated control method of the turbine engines of a rotary-wing aircraft, during a breakdown in one turbine engine, according to one implementation mode of the invention is illustrated in FIG. 1, the method being intended to be implemented by an electronic control unit.

The aircraft including an electronic control unit implementing a method of this type is a rotary-wing aircraft, such as a helicopter, comprising at least two turbine engines for the operation of the rotary wing.

In the examples illustrated in FIGS. 1 to 7, a configuration with only two turbine engines is assumed. But the invention is also applicable if there is more than one second turbine engine, the first turbine engine being the inoperative one.

The automated control method according to the invention is implemented following detection of a breakdown on a first turbine engine of the aircraft. The breakdown can correspond, for example, to an oil pressure fault or too high an oil temperature, or other breakdowns of the same level of importance, in other words breakdowns not involving stopping the operation of the turbine engine, but necessitating, however, the operation of the turbine engine in a degraded mode to preserve its integrity. These breakdowns can actually generate damage to the turbine engine if operation of the turbine engine is maintained under operating conditions that are too constraining.

Following the detection of an oil pressure fault for example, the automated control method according to the invention illustrated in FIG. 1 comprises, first of all, in a first step 100, verification of the operating state of all the turbine engines of the aircraft. If a breakdown impacting the nominal operation is detected in at least one of the turbine engines, the method according to the invention is aborted, otherwise continuing to the following step 102.

Then in a following step 102, the method comprises a determination of the flight phase in which the aircraft is situated.

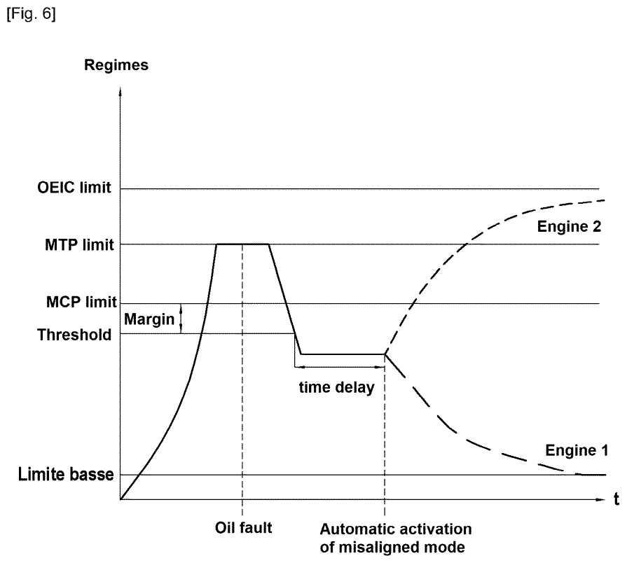

If a takeoff phase is detected in the first step 102, particularly by detection that the power delivered by at least one turbine engine is greater than a maximum continuous power threshold, the following steps of the method are not implemented. This until departure from the takeoff phase, as indicated in step 104, and as illustrated in FIG. 6 which will be described below.

When the aircraft is in a phase other than a takeoff phase, the method according to the invention accomplishes, in a step 110, activation of operation of the turbine engines in a misaligned mode, and, at the same time, in a step 120, activation of an indicator, for the pilot, of the activation of the misaligned mode, inviting the pilot to employ prudent piloting.

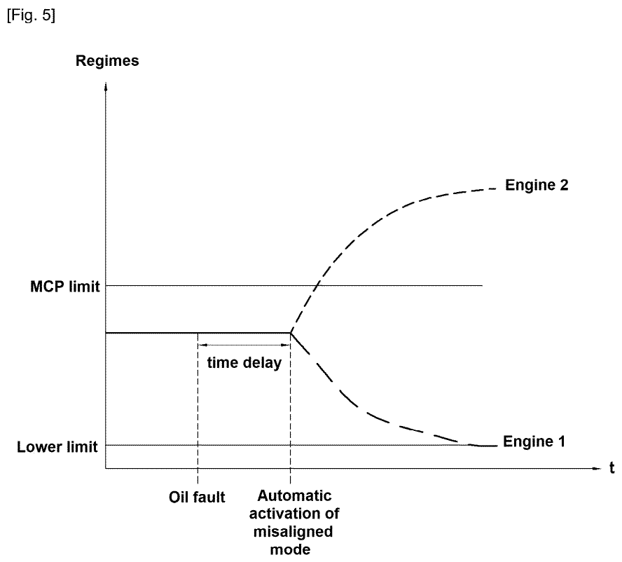

As illustrated in FIG. 5, which presents graphically the evolution of the speeds of the two turbine engines of an aircraft when the method of FIG. 1 is implemented, a delay time is used between the detection of the oil pressure fault and the activation of the misaligned mode in step 110. This delay time is used in order to ensure that the aircraft is not situated in a takeoff phase although the power regime of the turbine engines is less than the maximum continuous power regime (MCP), which represents the low threshold of the maximum takeoff power range (MTP).

Shown graphically in FIG. 6 is the evolution of the speeds of the two turbine engines of an aircraft when the method of FIG. 1 is implemented when the aircraft is in a takeoff phase when a breakdown is detected. In this FIG. 6, the breakdown is detected when the power regime of the turbine engines is in the MTP range. The method of FIG. 1 is not activated as indicated in step 104. It is necessary to wait for the pilot to command a reduction of the power regime of the turbine engines below a threshold value for the time delay to be launched and the misaligned mode to be automatically activated upon completion of the time delay if the regime is still below this threshold value.

The threshold in question corresponds to a power regime of the turbine engines that is strictly below the limit associated with the maximum continuous power level (MCP) of the aircraft. For the sake of safety, a margin of a few percent less than the MCP level is taken to fix this threshold.

As illustrated in FIGS. 5 and 6, and in FIG. 1, the step 110 of activating operation of the turbine engines in a misaligned mode comprises, in a step 112, a command for a progressive reduction in the power of the first turbine engine, Engine 1 and, in a step 114 simultaneous with the step 112, a command for a progressive increase in the power of the second turbine engine, Engine 2.

At the same time, in a step 130 following the step 110, the electronic control unit accomplishes setting a power limiter configured to limit the power of the turbine engines (Engine 1 and Engine 2) of the aircraft to a first maximum available power threshold, called the high maximum power threshold (OEIH) and corresponding to a maximum power usable by a turbine engine for a first limited period.

The progressive reduction in power of the first turbine engine, and the progressive increase in power of the second turbine engine are controlled in a complementary manner to maintain the rotation speed of the rotary wing at the rotation speed of a rotation speed setpoint of the rotary wing.

As indicated in step 116 in FIG. 1, the progressive reduction in the power of the first turbine engine and the progressive increase in the power of the second turbine engine are accomplished:
either until the power of the first turbine engine (denoted P1 in FIG. 1) reaches a lower power limit of the first turbine engine (denoted Lim in FIG. 1 and Lower limit in FIGS. 5 and 6), the power of the second turbine engine remaining less than a second maximum available power threshold (OEIL),
or until the power of the second turbine engine (denoted P2 in FIG. 1) reaches the second maximum available power threshold (denoted OEIL in FIG. 1), the power of the first turbine engine then having a value greater than the lower power limit of the first turbine engine.

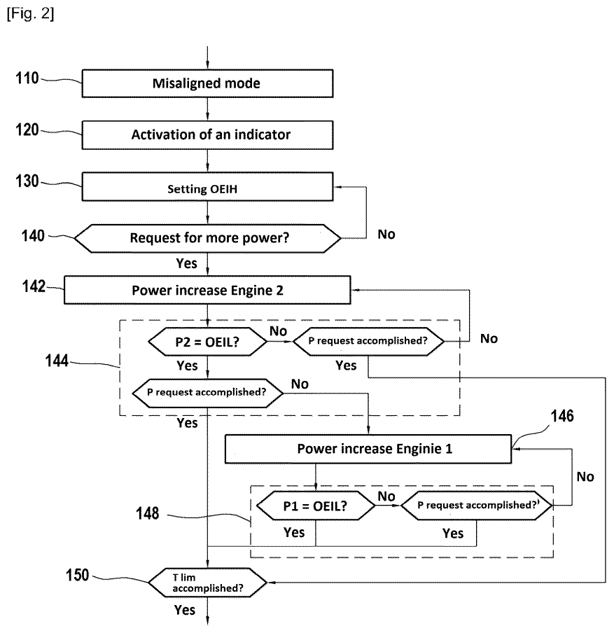

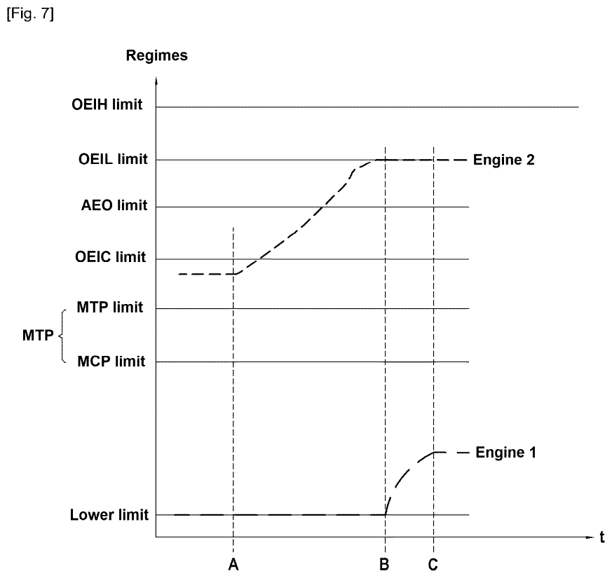

Illustrated in FIG. 2 is a method according to a second implementation mode of the invention. And the evolution of the speeds of the two turbine engines of and aircraft when the method of FIG. 2 is implemented is shown graphically in FIG. 7.

As illustrated in FIG. 2, if, following the activation of operation of the turbine engines in a misaligned mode a pilot issues, in a step 140 (denoted A in FIG. 7), a request for increasing power, the method also comprises, in a step 142, a command to increase the power of the second turbine engine (Engine 2) until, at most, the second maximum available power threshold (OEIL), as indicated in step 144. And, if the increase in power of the second turbine engine is insufficient for the turbine engines to develop in total (denoted P in FIG. 2) the power required by the pilot, the method also comprises an increase, in a step 146 (denoted B in FIG. 7), in the power of the first turbine engine (Engine 1) until, at most, the second maximum available power threshold (OEIL), as indicated in step 148 of FIG. 2. In FIG. 7, the total power required by the pilot developed by the two engines is reached in step C. The increase in power of the second turbine engine and, if needed, in the first turbine engine being accomplished for a limited period as indicated in step 150.

Nevertheless, if the speed setpoint of the rotary wing cannot be reached in this manner, increase in power of the turbomachines remains possible until the first maximum available power threshold (OEIH).

In FIG. 7, the regime level AEO corresponds to the conventional operating level of the two turbine engines (AEO).

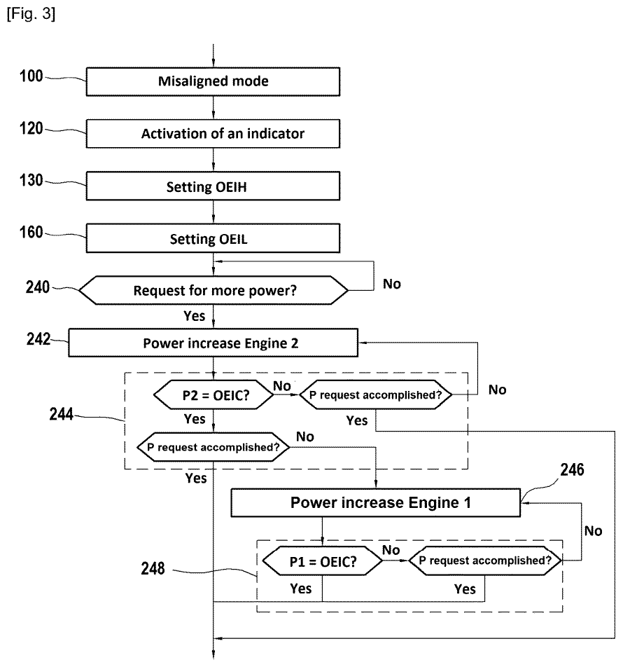

A method according to a third implementation mode of the invention is illustrated in FIG. 3.

As illustrated in FIG. 3, the pilot can command, in a step 160, setting a power limiter to limit the power of the turbine engines of the aircraft to a second maximum available power threshold (OEIL) corresponding to a maximum power usable by a turbine engine during a second limited period greater than the first limited period, the second maximum available power threshold (OEIL) being less than the first maximum available power threshold (OEIH).

In a case of this type, if, following the activation of operation of the turbine engines in a misaligned mode, a pilot issues, in a step 240, a request for increasing power, The method also comprises, in a step 242, a command to increase the power of said at least one second turbine engine until, at most, a third maximum available power threshold (OEIC), less than the second maximum available power threshold (OEIL), as indicated in step 144. And, if the increase in power of said at least one second turbine engine is insufficient for the turbines to develop in total the power required by the pilot, the method also comprises an increase, in step 246, in the power of said first turbine engine until, at most, the third maximum power available threshold (OEIC), as indicated in step 248.

In this configuration, the increase in power in the second turbine engine and, if needed, in said first turbine engine can be accomplished without time limitation.

Nevertheless, if the speed setpoint of the rotary wing cannot be reached in this manner, increase in power of the turbine engines remains possible until the second maximum available power threshold (OEIL).

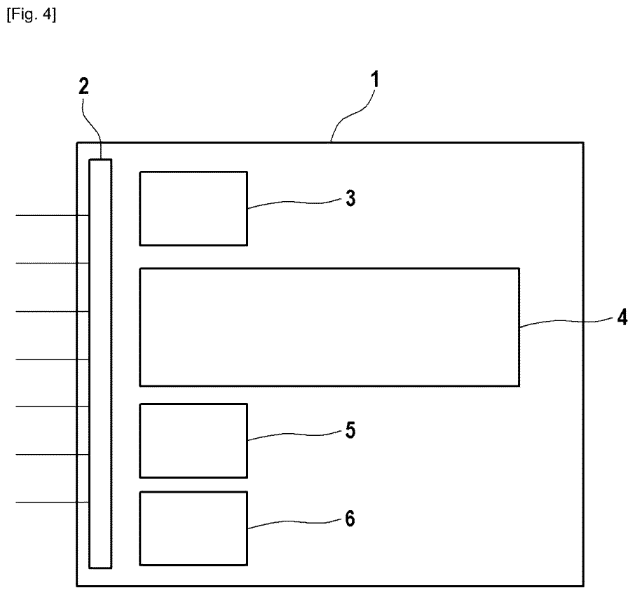

An electronic control unit according to one embodiment of the invention is illustrated schematically in FIG. 4.

The electronic control unit 1 is configured to automatically control the turbine engines of a multi-engine rotary-wing aircraft during a breakdown of one turbine engine.

The electronic control unit 1 comprises an input module 2 configured to receive signals detecting a breakdown in a first turbine engine among the turbine engines of the rotary-wing aircraft, a means 3 for determining the flight phase in which the aircraft is situated, and a means 4 for activating operation of the turbine engines in a misaligned mode. The means 4 for activating an operation of the turbine engines in a misaligned mode is configured to deliver, when the aircraft is in a phase other than a takeoff phase, a command to progressively reduce the power of said first turbine engine and a command to progressively increase the power of the at least one second turbine engine of the aircraft. The progressive reduction in power of the first turbine engine and the progressive increase in power of said at least one second turbine engine are controlled in a complementary manner to maintain the rotation speed of the rotary wing at the rotation speed of the rotation speed setpoint of the rotary wing.

The electronic control unit also comprises a means 5 for activating an indicator on an engine anomaly for the pilot, inviting him to employ prudent piloting, and a means 6 for setting a power limiter allowing selecting either the second maximum available power threshold (OEIL) or the third maximum available power threshold (OEIC) or to return to the first maximum available power threshold (OEIH), previously selected automatically following entry into the misaligned mode.

The method according to the invention thus supplies a technical solution allowing improving the safety of flights by reducing the pilot workload and particularly by avoiding recourse to selectors, sources of potential pilot errors.

1. An automated control method for the turbine engines of a rotary-wing aircraft provided with a plurality of turbine engines during a breakdown of one turbine engine, the method being intended to be implemented by an electronic control unit configured to receive a rotation speed setpoint of the rotary wing,
wherein, following detection of a breakdown of a first turbine engine among the turbine engines of the rotary-wing aircraft, the automated control method comprises:
determining the flight phase in which the aircraft is situated, then, when the aircraft is in a phase other than a takeoff phase,
activating operation of the turbine engines in a misaligned mode via commanding a progressive reduction in the power of said first turbine engine and commanding a progressive increase of the power of at least one second turbine engine of the aircraft, the progressive reduction in power of the first turbine engine and the progressive increase in power of said at least one second turbine engine being controlled in a complementary manner to maintain the rotation speed of the rotary wing at the wing rotation speed setpoint of the rotary wing, —activating an indicator, for the pilot, of an engine anomaly related to the detected breakdown, inviting him to employ prudent piloting, and
setting a power limiter configured to limit the power of the turbine engines of the aircraft to a first maximum available power threshold (OEIH) corresponding to a maximum power usable by a turbine engine for a first limited period.

2. The automated control method according to claim 1, wherein a takeoff phase is detected when the power delivered by at least one turbine engine is greater than a continuous maximum power threshold.

3. The automated control method according to claim 1, also comprising, prior to activating operation of the turbine engines in a misaligned mode, verification of the operating state of all turbine engines, the misaligned mode being held inactive if a breakdown impacting the nominal operation of at least one turbine engine is detected.

4. The automated control method according to claim 1, wherein the progressive reduction in power of said first turbine engine and the progressive increase of in power of at least one second turbine engine of the aircraft are accomplished until the power of the first turbine engine reaches a lower power limit, the power of said at least one second turbine engine remaining less than a second maximum available power threshold, or until the power of said at least one second turbine engine reaches the second maximum available power threshold, the power of said first turbine engine having a value greater than said lower power limit of the first turbine engine.

5. The automated control method according to claim 1, wherein if, following the activation of operation of the turbine engines in a misaligned mode, a pilot issues a power increase request, the method comprises a power increase command, the method comprises a command to increase the power of said at least one turbine engine until, at most, a second maximum available power threshold, and, if the increase of power of said at least one second turbine engine is insufficient for the turbine engines to develop in total the power required by the pilot, a command for increasing the power of said first turbine engine until, at most, the second maximum available power threshold-(OEIL), the increase in power on said at least one second turbine engine, and, if needed, of said first turbine engine being accomplished for a limited period.

6. The automated control method according to claim 4, wherein the pilot commands the setting of a power limiter to limit the power of the turbine engines of the aircraft to a second maximum available power threshold corresponding to a maximum power usable by a turbine engine for a second limited period greater than the first limited period, the second maximum available power threshold being less than the first maximum available power threshold.

7. The automated control method according to claim 6, wherein if, following the activation of operation of the turbine engines in a misaligned mode, a pilot issues a power increase request, the method comprises a command to increase the power of said at least one second turbine engine until, at most, a third maximum available power threshold less than the second maximum available power, and, if the power increase of said at least one second turbine engine is insufficient for the turbine engines to develop in total the power required by the pilot, a command to increase the power of said first turbine engine until, at most, the third maximum available power threshold, the power increase in said at least one second turbine engine and, if needed, in said first turbine engine which can be accomplished for an unlimited period.

8. An electronic control unit for a rotary-wing aircraft provided with a plurality of turbine engines, the electronic control unit being configured to receive a rotation speed setpoint of the rotary wing and automatically control the turbine engines of the aircraft during a breakdown of one turbine engine, the electronic control unit comprising:
an input module configured to receive signals detecting a breakdown in a first turbine engine among the turbine engines of the rotary wing aircraft,
a means for determining the flight phase in which the aircraft is situated,
a means for activating operation of the turbine engines in a misaligned mode configured to deliver, when the aircraft is in a phase other than a takeoff phase, a command to progressively reduce the power of said first turbine engine and a command to progressively increase the power of at least one second turbine engine of the aircraft, the progressive reduction in power of the first turbine engine and the progressive increase in power of said at least one second turbine engine being controlled in a complementary manner to maintain the rotation speed of the rotating wing at the rotation speed of the rotation speed setpoint of the rotary wing,
a means for activating an indicator of an engine anomaly for the pilot, inviting him to employ prudent piloting, and
a means for setting a power limiter configured to limit the power of the turbine engines of the aircraft to at least a first maximum available power threshold-corresponding to a maximum power usable by a turbine engine for a first limited period.

9. A rotary wing aircraft comprising at least two turbomachines and an electronic control unit according to claim 8.
